(19) United States
(12) Patent Application Publication
(10) Pub. No.: US 2026/0357760 A1
(43) Pub. Date: Nov. 12, 2026

(54) ELECTRONICALLY CONTROLLED HYDROGEN COMBUSTION ENGINE SYSTEM WITH INTEGRATED SAFETY AND MONITORING

(71) Applicant: Naya Holdings, LLC, Cherry Hill, NJ (US)

(72) Inventor: Himanshu B. Patel, Cherry Hill, NJ (US)

(73) Assignee: Naya Holdings, LLC, Cherry Hill, NJ (US)

(21) Appl. No.: 19/564,900

(22) Filed: Mar. 12, 2026

Related U.S. Application Data
(60) Provisional application No. 63/770,962, filed on Mar. 12, 2025.

(51) Int. Cl. F02D 41/00; F02D 1/02; F02D 41/14; F02D 41/22; F17C 1/14; F17C 1/16

(52) U.S. Cl. CPC F02D 41/0027; F02D 1/02; F02D 41/008; F02D 41/009; F02D 41/1402; F02D 41/22; F17C 1/14; F17C 1/16; F02D 2200/0404; F02D 2200/0406; F02D 2200/0602; F02D 2200/0606; F02D 2200/0611; F17C 2201/0104; F17C 2203/0631; F17C 2203/0646; F17C 2203/0673; F17C 2221/012; F17C 2223/036

(57) ABSTRACT

An electronically controlled hydrogen combustion engine system comprises a plurality of hydrogen injectors configured for pulse-width modulated fuel delivery, each injector corresponding to a respective engine cylinder. An ignition system comprises at least one ignition coil per cylinder. A plurality of sensors comprises temperature sensors, pressure sensors, knock sensors, lambda sensors, crankshaft and camshaft position sensors, and a throttle position sensor. An electronic control unit (ECU) in communication with the sensors and ignition system is configured to process real-time sensor data, control hydrogen injector timing and pulse width, adjust ignition timing based on combustion conditions, and execute safety protocols when abnormal conditions are detected. A hydrogen pressure regulation assembly comprises a pressure regulating valve and purge valve in communication with the ECU. A software interface displays real-time parameters, records performance data, and facilitates diagnostics and remote monitoring.

### CROSS-REFERENCE TO RELATED APPLICATIONS

This application claims priority to U.S. Provisional Application No. 63/770,962, filed Mar. 12, 2025, which is herein incorporated by reference in its entirety.

### FIELD OF INVENTION

The present disclosure relates to hydrogen internal combustion engines and electronic control systems therefor, and more particularly to an electronically controlled hydrogen combustion engine system integrating an electronic control unit, a distributed sensor network, a hydrogen pressure regulation assembly, and a software interface for real-time monitoring, adaptive combustion optimization, and automated safety control across vehicular, industrial, marine, and stationary power generation applications.

### BACKGROUND

Hydrogen internal combustion engines represent a developing area of propulsion and power generation technology that offers reduced emissions compared to conventional fossil-fuel-based internal combustion engines. Hydrogen combustion produces primarily water vapor as a byproduct, making hydrogen an attractive fuel source for applications seeking to reduce carbon emissions. However, hydrogen possesses combustion characteristics that differ substantially from conventional hydrocarbon fuels, including a higher flame speed, lower ignition energy, and a wider flammability range. These properties present challenges when adapting existing internal combustion engine architectures to operate on hydrogen fuel.

Conventional approaches to hydrogen engine adaptation have encountered difficulties in achieving efficient fuel delivery and precise ignition timing control. The distinct combustion behavior of hydrogen can lead to phenomena such as pre-ignition, knocking, and backfiring when engine control systems are not appropriately configured for hydrogen operation. These issues may be exacerbated when hydrogen adaptation is applied to engines of varying configurations, including single-cylinder engines, multi-cylinder inline configurations, and larger V-type engine layouts used in industrial, marine, and stationary power generation applications.

Electronic control systems for internal combustion engines have evolved to provide real-time management of fuel injection, ignition timing, and other combustion parameters. Such systems typically employ electronic control units that receive input from various sensors distributed throughout the engine and issue commands to actuators controlling fuel delivery and ignition events. The integration of comprehensive sensor networks enables closed-loop feedback control, wherein measured combustion results are compared against target parameters and control outputs are adjusted accordingly.

Safety considerations are particularly relevant in hydrogen-fueled engine systems due to the physical and chemical properties of hydrogen gas. Hydrogen is highly diffusive, has a low ignition energy, and can form flammable mixtures over a wide range of concentrations in air. These characteristics create demands for monitoring systems capable of detecting leaks, overpressure conditions, and other abnormal operating states, as well as control mechanisms capable of executing protective actions in response to detected hazards.

Real-time monitoring and diagnostic capabilities provide operators with visibility into engine operating conditions and can facilitate maintenance planning and performance optimization. Software interfaces that display operating parameters, record performance data, and provide diagnostic information can support the operation of hydrogen-fueled engines across diverse application contexts. The ability to monitor and analyze engine performance data may also enable predictive approaches to maintenance and system optimization.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Some exemplary embodiments are related to an electronically controlled hydrogen combustion engine system. The system includes a plurality of hydrogen injectors configured for pulse-width modulated fuel delivery, each injector corresponding to a respective engine cylinder. The system includes an ignition system comprising at least one ignition coil per cylinder. The system includes a plurality of sensors comprising temperature sensors, pressure sensors, knock sensors, lambda sensors, crankshaft and camshaft position sensors, and a throttle position sensor. The system includes an electronic control unit (ECU) in electronic communication with the plurality of sensors and the ignition system. The ECU is configured to process real-time sensor data, control hydrogen injector timing and pulse width, adjust ignition timing based on combustion conditions, and execute safety and shutdown protocols when abnormal conditions are detected. The system includes a hydrogen pressure regulation assembly comprising a pressure regulating valve and a purge valve in communication with the ECU. The system includes a software interface configured to display real-time parameters, record performance data, and facilitate diagnostics and remote monitoring. According to other aspects of the present disclosure, the system may be scalable and configurable for engines having from one to sixteen cylinders and for applications including vehicular, marine, industrial, and stationary engines. The ECU may communicate with the plurality of sensors and the plurality of hydrogen injectors via a Controller Area Network (CAN) protocol to provide modular scalability for multi-cylinder configurations. The ECU may dynamically adjust fuel injection timing based on manifold absolute pressure, throttle position, and crankshaft angle to optimize combustion efficiency. The system may further comprise a three-layer hydrogen storage tank having an aluminum inner liner, a glass fiber intermediate layer, and a polymer outer shell, configured to supply hydrogen at variable pressures. The knock sensors may be configured to detect detonation in any cylinder and the ECU may selectively retard ignition timing for an affected cylinder in response to detected detonation. The software interface may display air-to-fuel ratio, temperature, cylinder pressure, and power output in real time. The system may further comprise a battery management system managing a lithium iron phosphate battery that powers the ECU and the plurality of sensors. The purge valve may automatically vent residual hydrogen upon engine shutdown or upon detection of overpressure by the pressure sensors. The ECU may perform adaptive learning of ignition timing parameters for different engine architectures via calibration algorithms stored in ECU memory. The ECU may synchronize crankshaft and camshaft position data from the crankshaft and camshaft position sensors to manage ignition and fuel timing across cylinder configurations including single-cylinder and V16 layouts.

Other exemplary embodiments are related to an integrated safety control system for a hydrogen-fueled internal combustion engine. The system includes a plurality of pressure sensors, hydrogen concentration sensors, and temperature sensors configured to monitor hydrogen storage and combustion conditions. The system includes a hydrogen purge valve and a pressure regulating valve each connected to a hydrogen supply manifold. The system includes a master relay and at least one control relay configured to disconnect electrical power and hydrogen flow under abnormal conditions. The system includes an electronic control unit (ECU) electrically coupled to the sensors, the purge valve, the pressure regulating valve, and the relays. The ECU is configured to receive sensor data in real time, determine whether any monitored parameter exceeds a predetermined safety threshold, and in response to detecting such a condition, deactivate hydrogen injection, disable ignition, and actuate the purge valve to vent residual hydrogen. The system automatically returns the engine to a safe state without operator intervention and is adaptable for use with single-cylinder through multi-cylinder engines. According to other aspects of the present disclosure, the ECU may be configured to execute software-based fault diagnostics that cross-check real-time sensor data for plausibility, and upon detection of an anomaly, deactivate one or more hydrogen injectors and initiate a controlled system shutdown. The system may further comprise a hydrogen storage cylinder having a three-layer construction including an aluminum inner liner, a glass-fiber composite intermediate layer, and a polymer outer layer, the cylinder being configured to withstand hydrogen containment pressures exceeding 700 bar. The ECU may be further configured to implement a purge and vent control sequence upon engine shutdown, the sequence comprising timed activation of the purge valve and deactivation of hydrogen injectors to evacuate residual hydrogen from manifolds and injectors prior to restart. The master relay may be configured to disconnect electrical power to a hydrogen control valve, the ignition system, and an actuator network during emergency shutdown conditions initiated by the ECU in response to the detected anomaly.

Still further exemplary embodiments are related to a method for controlling a hydrogen combustion engine through software-based monitoring and adaptive regulation. The method includes receiving, by an electronic control unit (ECU), continuous data signals from a plurality of sensors measuring temperature, pressure, knock, air-to-fuel ratio, and rotational position. The method includes processing the data through embedded control algorithms stored in ECU memory. The method includes determining injector pulse width and ignition timing values based on current load and speed conditions. The method includes transmitting control signals from the ECU to a plurality of actuators including hydrogen injectors, ignition coils, and pressure valves to maintain target combustion parameters. The method includes monitoring for deviations between actual and desired operating conditions. The method includes automatically adjusting injection timing, ignition advance, or pressure regulation in response to said deviations to maintain stable hydrogen combustion and prevent unsafe operation. The method provides closed-loop feedback control across any engine configuration operating on hydrogen fuel. According to other aspects of the present disclosure, determining injector pulse width and ignition timing values may comprise dynamically adjusting fuel injection timing based on manifold absolute pressure, throttle position, and crankshaft angle received from the plurality of sensors. The method may further comprise detecting detonation via knock sensors and selectively retarding ignition timing for an affected cylinder in response to the detected detonation. Automatically adjusting injection timing, ignition advance, or pressure regulation may comprise synchronizing crankshaft and camshaft position data to manage ignition and fuel timing across cylinder configurations including single-cylinder and multi-cylinder layouts.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 depicts a block diagram of a sensor integration and electronic control unit communication architecture for an electronically controlled hydrogen combustion engine system, according to aspects of the present disclosure.

FIG. 2 depicts a block diagram illustrating electronic communication pathways between an electronic control unit and engine components for the hydrogen combustion engine system of FIG. 1, according to aspects of the present disclosure.

FIG. 3 depicts a block diagram of a safety mechanism for the electronically controlled hydrogen combustion engine system of FIG. 1, according to aspects of the present disclosure.

### DETAILED DESCRIPTION

An electronically controlled hydrogen combustion engine system provides a platform for adapting conventional internal combustion engines to operate on hydrogen fuel. The electronically controlled hydrogen combustion engine system may be compatible with any conventional internal combustion engine, regardless of cylinder count from single-cylinder configurations to V16 configurations. The electronically controlled hydrogen combustion engine system may be applied across a range of applications including vehicular contexts such as trucks, cars, and motorcycles, industrial machinery, marine propulsion systems, and stationary power generators. The electronically controlled hydrogen combustion engine system enables hydrogen fuel operation while addressing the distinct combustion characteristics of hydrogen, such as high flame speed, low ignition energy, and wide flammability range, across these diverse engine types and operational environments.

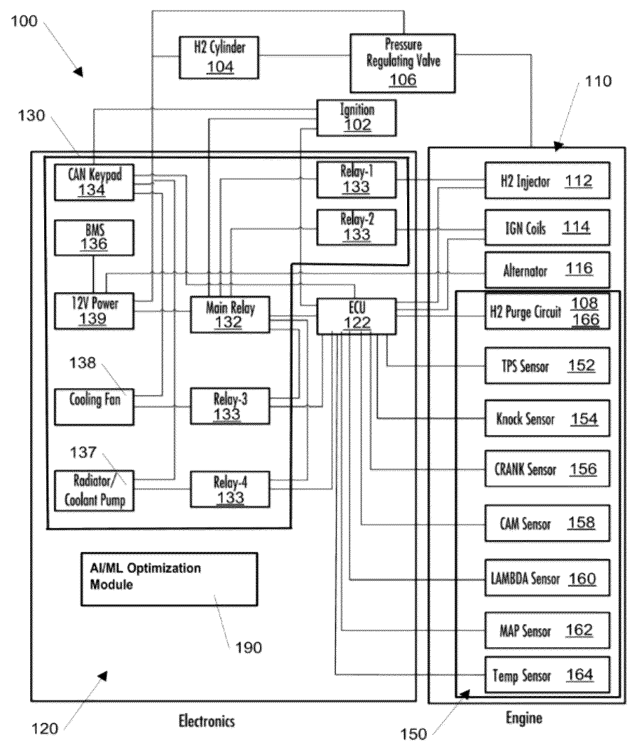

Referring to FIG. 1, an electronically controlled hydrogen combustion system 100 includes an engine with engine components 110 connected to an electronic control system 120. The electronically controlled hydrogen combustion system 100 integrates hardware and software subsystems that cooperate to deliver precise fuel metering, ignition timing, and safety control across various engine configurations. The engine components 110 may be electronically connected to the electronic control system 120. The electronic control system 120 may include electronic components 130 and an electronic control unit. The engine components 110 and the electronic control system 120 may also be connected with an ignition 102, one or more hydrogen cylinders 104, and one or more pressure regulating valves 106.

With continued reference to FIG. 1, the hydrogen cylinders 104 provide a source of hydrogen fuel for the electronically controlled hydrogen combustion system 100. The hydrogen cylinders 104 may be connected to the pressure regulating valves 106, which form part of a hydrogen fuel delivery pathway. The pressure regulating valves 106 may control hydrogen gas flow and may be adaptable to varying engine sizes and pressures. The pressure regulating valves 106 may adjust hydrogen supply pressure dynamically based on engine demand. One or more purge valves 108 may be included in the electronically controlled hydrogen combustion system 100. The purge valves 108 may vent residual hydrogen during shutdown or fault conditions to enhance system safety.

The ignition 102 may be positioned within the electronic control system 120 and may provide ignition enablement for the electronically controlled hydrogen combustion system 100. The ignition 102 may be connected to a starter motor that initiates engine operation. The electronic components 130 within the electronic control system 120 may include a CAN keypad 134, a battery management system 136, a power supply 139, a main relay 132, one or more control relays 133, a cooling fan 138, and a radiator or coolant pump 137. A plurality of sensors 150 may be included within the engine components 110 to provide data acquisition and feedback for the electronically controlled hydrogen combustion system 100.

As further shown in FIG. 1, an AI/LLM optimization module 190 may be included within the electronic control system 120. The AI/LLM optimization module 190 may be connected to the electronic control unit and may receive data from the sensors 150. The AI/LLM optimization module 190 may analyze data using machine-learning algorithms and may generate control recommendations or adaptive parameters for combustion optimization.

The electronically controlled hydrogen combustion system 100 may operate on a 12V power supply, supported by an alternator and a starter motor. The 12V power supply may be scalable to the engine's needs across different configurations. The electronically controlled hydrogen combustion system 100 may be scalable and configurable for engines having from one to sixteen cylinders. The electronically controlled hydrogen combustion system 100 may be configured for applications including vehicular, marine, industrial, and stationary engines. The scalable architecture of the electronically controlled hydrogen combustion system 100 allows adaptation to any cylinder configuration from single-cylinder engines to V16 layouts while maintaining consistent control and safety functionality across all engine types and operational contexts.

An electronic control unit (ECU) 122 may serve as the central processing and command subsystem of the hydrogen combustion control architecture for the electronically controlled hydrogen combustion system 100. The ECU 122 may be electronically coupled to the sensors 150 and an ignition system. The ECU 122 may function as the computational core that interprets sensor inputs and issues control signals to regulate aspects of hydrogen combustion.

The ECU 122 may be configured to process real-time sensor data. In operation, the ECU 122 may continuously receive real-time data streams from the sensors 150, including temperature, pressure, throttle position, crankshaft and camshaft position, knock, and lambda sensors. These signals may be processed by onboard analog-to-digital converters and microprocessors that execute embedded control algorithms to determine fuel injection timing, ignition advance, and hydrogen pressure regulation parameters.

The ECU 122 may be configured to control hydrogen injector timing and pulse width. The ECU 122 may control the opening duration and frequency of each hydrogen injector, transmitting digital and pulse-width modulated control signals to implement fuel delivery commands. The ECU 122 may also be configured to adjust ignition timing based on combustion conditions. The ECU 122 may trigger ignition coils at calculated crankshaft angles and adjust the pressure regulating valves 106 and the purge valves 108 in accordance with combustion conditions.

The ECU 122 may be configured to execute safety and shutdown protocols when abnormal conditions are detected. Upon detection of abnormal conditions such as overpressure, hydrogen leakage, or sensor anomalies, the ECU 122 may initiate automated shutdown procedures to return the engine to a safe state.

The ECU 122 may operate as part of a closed-loop feedback system, wherein output responses measured by the sensors 150 are continuously compared to desired setpoints or reference maps stored in the ECU's memory. Based on these comparisons, the ECU 122 may dynamically refine control outputs to maintain stable, efficient, and low-emission hydrogen combustion under varying load, speed, and environmental conditions.

The ECU 122 may communicate with the sensors 150 and a plurality of hydrogen injectors via a Controller Area Network (CAN) protocol to provide modular scalability for multi-cylinder configurations. The ECU 122 may communicate over the CAN protocol or an equivalent high-speed data bus to synchronize operations with auxiliary modules, such as a battery management system, a software visualization platform, and an AI/LLM optimization module. This integrated communication structure of the ECU 122 allows subsystems to function cohesively, providing consistent control across single-cylinder through multi-cylinder engine configurations including V16 layouts.

The sensors 150 may comprise a distributed sensor network positioned throughout the engine and supporting systems of the electronically controlled hydrogen combustion system 100. The sensors 150 may include temperature sensors 164, pressure sensors 162, knock sensors 154, lambda sensors 160, crankshaft and camshaft position sensors, and a throttle position sensor 152. Each sensor from the sensors 150 may convert a physical condition into an electrical signal that is transmitted to the ECU 122 through shielded signal lines or a Controller Area Network (CAN) communication bus. The sensor network may serve as the input layer of the closed-loop control system by observing and reporting the instantaneous operating state of the engine and the electronically controlled hydrogen combustion system 100, enabling the ECU 122 to command precise injector timing, ignition events, and pressure regulation.

A throttle position sensor (TPS) 152 may track throttle valve position and adjust fuel injection based on throttle input. The throttle position sensor 152 may be applicable to all throttle-controlled engines and may align fuel delivery with operator demand. The ECU 122 may dynamically adjust fuel injection timing based on manifold absolute pressure, throttle position, and crankshaft angle to optimize combustion efficiency. The throttle position sensor 152 may provide throttle position data to the ECU 122 as part of this dynamic adjustment process.

Knock sensors 154 may detect pre-ignition or detonation within the engine cylinders. The knock sensors 154 may be deployable across single or multi-cylinder setups. The knock sensors 154 may be configured to detect detonation in any cylinder, and the ECU 122 may selectively retard ignition timing for an affected cylinder in response to detected detonation. The knock sensors 154 may convert mechanical vibrations associated with abnormal combustion events into electrical signals for processing by the ECU 122.

Crank sensors 156 may track crankshaft positions for timing synchronization in any engine design. The crank sensors 156 may provide crankshaft angle data to the ECU 122 for determining injection timing and ignition events. Cam sensors 158 may track camshaft positions for timing synchronization in any engine design. The cam sensors 158 may work in conjunction with the crank sensors 156 to provide the ECU 122 with rotational position data for synchronizing fuel injection and ignition across all cylinder configurations.

Lambda sensors 160 may measure air-to-fuel ratio (AFR) in exhaust gases for combustion optimization. The lambda sensors 160 may provide closed-loop control feedback to the ECU 122, allowing the ECU 122 to adjust hydrogen injection parameters to maintain a target air-to-fuel ratio.

Pressure sensors 162 may include manifold absolute pressure (MAP) sensors and cylinder pressure sensors. The pressure sensors 162 may be scalable to assess load and combustion conditions in any engine configuration. The pressure sensors 162 may provide manifold absolute pressure data to the ECU 122 for load calculation and dynamic adjustment of fuel injection timing.

Temperature sensors 164 may monitor thermal conditions at locations including the cylinder head, intake, and exhaust. The temperature sensors 164 may be positioned regardless of engine layout to provide thermal data to the ECU 122 for combustion control and thermal protection.

Hydrogen purge circuit sensors 166 may include leak detection sensors to ensure safety by monitoring hydrogen levels. The hydrogen purge circuit sensors 166 may continuously monitor system safety and provide hydrogen concentration data to the ECU 122. Upon detection of elevated hydrogen levels by the hydrogen purge circuit sensors 166, the ECU 122 may initiate safety protocols including actuation of the purge valves 108.

A custom actuator network may function as the execution layer of the electronically controlled hydrogen combustion system 100, converting electrical control signals generated by the ECU 122 into mechanical, electrical, or fluidic actions that directly regulate the performance of the electronically controlled hydrogen combustion system 100. The custom actuator network may be electrically and communicatively coupled to the ECU 122 through driver circuits, power relays, and communication buses. The custom actuator network may be responsible for implementing all commanded control operations related to fuel delivery, ignition, pressure regulation, and system safety.

The custom actuator network may include a plurality of hydrogen fuel injectors 112, ignition coils 114, the pressure regulating valves 106, the purge valves 108, and auxiliary actuators such as cooling pumps and fans. The hydrogen fuel injectors 112 may be configured for pulse-width modulated fuel delivery, with each hydrogen fuel injector 112 corresponding to a respective engine cylinder. Each hydrogen fuel injector 112 may be configured to deliver hydrogen gas to a corresponding combustion chamber in response to pulse-width modulated control signals from the ECU 122. The hydrogen fuel injectors 112 may be heavy-duty injectors engineered for high-pressure hydrogen and adaptable to any cylinder count. The hydrogen fuel injectors 112 may be scaled to the number of cylinders, for example, one hydrogen fuel injector 112 for a single-cylinder engine and up to sixteen hydrogen fuel injectors 112 for a V16 engine configuration.

An ignition system may comprise at least one ignition coil 114 per cylinder. Each ignition coil 114 may produce a precisely timed high-voltage discharge to ignite the hydrogen-air mixture within the corresponding combustion chamber. The ignition coils 114 may be individually triggered based on timing logic executed by the ECU 122. The ignition coils 114 may be scaled to the number of cylinders, for example, one ignition coil 114 for a single-cylinder engine and up to sixteen ignition coils 114 for a V16 engine configuration.

An alternator 116 may provide electrical power generation for the electronically controlled hydrogen combustion system 100. The alternator 116 may supply charging current to a battery and may support the 12V power supply that powers the ECU 122, the sensors 150, and the custom actuator network. The alternator 116 may be sized according to the electrical demands of the engine configuration.

The custom actuator network may operate in continuous coordination with the ECU 122 and the sensors 150 within a closed-loop control architecture. As sensor data are processed by the ECU 122, real-time command signals may be transmitted to the custom actuator network to adjust injection timing, ignition advance, or valve position, thereby ensuring stable combustion, improved thermal efficiency, and reduced emissions.

The custom actuator network may also execute safety-related functions upon receipt of emergency shutdown commands from the ECU 122. Such safety-related functions may include closing a hydrogen main valve or de-energizing ignition circuits. Upon detection of abnormal conditions by the sensors 150, the ECU 122 may command the custom actuator network to halt fuel supply and spark generation.

The scalable and modular configuration of the custom actuator network may allow the electronically controlled hydrogen combustion system 100 to be applied universally across single-cylinder engines through large multi-cylinder configurations, including V16 layouts. The custom actuator network may enable consistent and precise control regardless of engine type or intended application.

The electronic components 130 may include a main relay 132, one or more control relays 133, a CAN keypad, a CAN keypad 134, a battery management system, a BMS 136, a coolant pump 137, a cooling fan 138, and a power supply 139. The electronic components 130 may support power distribution, thermal management, and user interface functions for the electronically controlled hydrogen combustion system 100.

The main relay 132 may manage power distribution to high-load devices within the electronically controlled hydrogen combustion system 100. The main relay 132 may be adjustable to the engine's power requirements and may provide centralized power management. The main relay 132 may enable system-wide deactivation during emergency conditions such as leak detection, sensor failure, or external operator command. The main relay 132 may be controlled by the ECU 122 to disconnect electrical power to a hydrogen control valve, the ignition coils 114, and the custom actuator network during emergency shutdown conditions.

The control relays 133 may operate high-power components within the electronically controlled hydrogen combustion system 100. The control relays 133 may be scaled to the application and may govern hydrogen flow and ignition enablement. The ECU 122 may command de-energization of the control relays 133 upon fault detection, thereby halting fuel supply and spark generation.

The CAN keypad 134 may provide a user interface for ignition and power control via the Controller Area Network (CAN) protocol. The CAN keypad 134 may be universally applicable across engine configurations. The CAN keypad 134 may enable user interaction for manual ignition enablement and system diagnostics control. The CAN keypad 134 may communicate with the ECU 122 over the CAN protocol to provide operator input for system control functions.

The battery management system (BMS) 136 may oversee a 12V lithium iron phosphate (LFP) battery, ensuring stable power for any setup. The battery management system 136 may manage a lithium iron phosphate battery that powers the ECU 122 and the sensors 150. The lithium iron phosphate battery may provide a stable power source for the electronic components 130 and the sensors 150 during engine operation. The battery management system 136 may monitor battery state of charge, voltage, and temperature to maintain battery health and provide consistent power delivery.

The custom actuator network may also be communicatively coupled to auxiliary control modules, including the battery management system and a CAN-based software interface, to coordinate power distribution and operational diagnostics. The battery management system may communicate with the ECU 122 to provide battery status information and to coordinate power management across the electronically controlled hydrogen combustion system 100.

The coolant pump 137 may circulate coolant through the engine and associated thermal management components. The coolant pump 137 may be controlled by the control relays 133 under command from the ECU 122. The cooling fan 138 may provide forced air cooling for thermal management of the engine and electronic components 130. The cooling fan 138 may be controlled by the control relays 133 based on temperature data received from the temperature sensors 164.

The power supply 139 may provide 12V electrical power to the ECU 122, the sensors 150, and the custom actuator network. The power supply 139 may receive charging current from the alternator 116 during engine operation. The power supply 139 may comprise the lithium iron phosphate battery managed by the battery management system 136.

A starter motor 105 may integrate with the power system to provide engine cranking during startup. The starter motor 105 may receive electrical power from the power supply 139 through the ignition 102. The starter motor 105 may be energized upon operator command through the CAN keypad 134 to initiate engine rotation for starting. The starter motor 105 may be sized according to the engine configuration and cranking torque requirements.

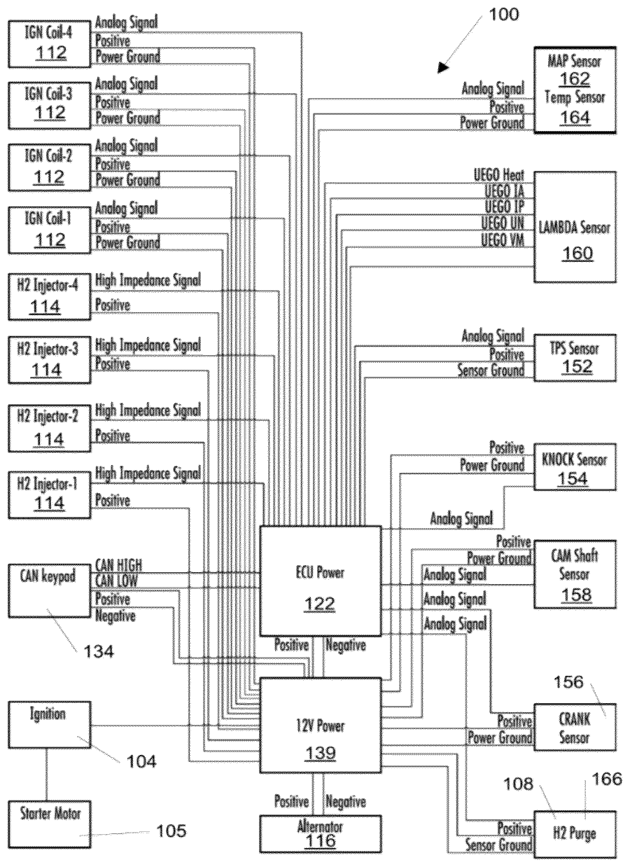

Referring to FIG. 2, the electronically controlled hydrogen combustion system 100 includes a sensor integration and electronic control unit communication architecture that establishes electronic communication pathways between the ECU 122 and the engine components 110. FIG. 2 illustrates the connection topology through which the ECU 122 receives sensor inputs and transmits control signals to actuators within the electronically controlled hydrogen combustion system 100.

The ECU 122 may receive analog signals from the sensors 150 through dedicated signal lines. The pressure sensors 162, which may include a manifold absolute pressure (MAP) sensor, may connect to the ECU 122 via analog signal, positive, and power ground lines. The MAP sensor may provide manifold pressure data to the ECU 122 for load calculation and fuel injection timing adjustment. The temperature sensors 164 may connect to the ECU 122 via analog signal, positive, and power ground lines to provide thermal data from locations including the intake, exhaust, and cylinder head.

With continued reference to FIG. 2, the lambda sensors 160 may connect to the ECU 122 through multiple signal lines including UEGO heat, UEGO IA, UEGO IP, UEGO UN, and UEGO VM connections. The lambda sensors 160 may provide air-to-fuel ratio measurements from exhaust gases to enable closed-loop combustion control. Throttle position sensors (TPS) 152 may connect to the ECU 122 via analog signal, positive, and power ground lines. The throttle position sensors 152 may track throttle valve position and provide operator demand data to the ECU 122 for modulating hydrogen injection rate.

The knock sensors 154 may connect to the ECU 122 via analog signal and ground lines. The knock sensors 154 may detect abnormal combustion events and transmit corresponding electrical signals to the ECU 122. The cam sensors 158 may connect to the ECU 122 via analog signal, positive, power ground, and sensor ground connections. The crank sensors 156 may connect to the ECU 122 via analog signal, positive, power ground, and sensor ground connections. The ECU 122 may synchronize crankshaft and camshaft position data from the crank sensors 156 and the cam sensors 158 to manage ignition and fuel timing across cylinder configurations including single-cylinder and V16 layouts.

As further shown in FIG. 2, the ignition coils 114 may receive control signals from the ECU 122. FIG. 2 depicts four ignition coils 114 labeled IGN Coil-1 through IGN Coil-4, each connected to the ECU 122 via analog signal, positive, and power ground lines. The ECU 122 may transmit precisely timed trigger signals to each ignition coil 114 to initiate high-voltage discharge at calculated crankshaft angles.

The hydrogen fuel injectors 112 may receive control signals from the ECU 122. FIG. 2 depicts four hydrogen fuel injectors 112 labeled H2 Injector-1 through H2 Injector-4, each connected to the ECU 122 via high impedance signal and positive lines. The ECU 122 may transmit pulse-width modulated control signals to each hydrogen fuel injector 112 to control the opening duration and frequency for hydrogen delivery to corresponding combustion chambers.

The CAN keypad 134 may connect to the ECU 122 through CAN HIGH, CAN LOW, positive, and negative connections. The CAN keypad 134 may enable user interaction for manual ignition enablement and system diagnostics control. The CAN keypad 134 may communicate with the ECU 122 over the Controller Area Network (CAN) protocol to provide operator input for system control functions.

The hydrogen purge circuit sensors 166 may connect to the ECU 122 via positive and sensor ground lines through the purge valves 108. The hydrogen purge circuit sensors 166 may continuously monitor hydrogen concentration levels and transmit data to the ECU 122 for safety monitoring. Upon detection of elevated hydrogen levels, the ECU 122 may initiate actuation of the purge valves 108 to vent residual hydrogen.

The alternator 116 may provide positive and negative connections to the power supply 139. The power supply 139 may distribute 12V electrical power to the ECU 122 and the sensors 150. The ignition 102 may connect to the starter motor 105 to provide ignition enablement for engine starting.

Sensor data from the sensors 150 may also be routed to a software interface and an AI/LLM optimization module. The software interface and the AI/LLM optimization module may analyze historical and live operating trends for efficiency optimization, diagnostics, and predictive maintenance.

The ECU 122 may perform adaptive learning of ignition timing parameters for different engine architectures via calibration algorithms stored in ECU memory. The calibration algorithms may enable the ECU 122 to refine ignition timing maps based on operational data collected from the sensors 150. The adaptive learning capability may allow the ECU 122 to accommodate variations in engine architecture and operating conditions across single-cylinder through V16 configurations.

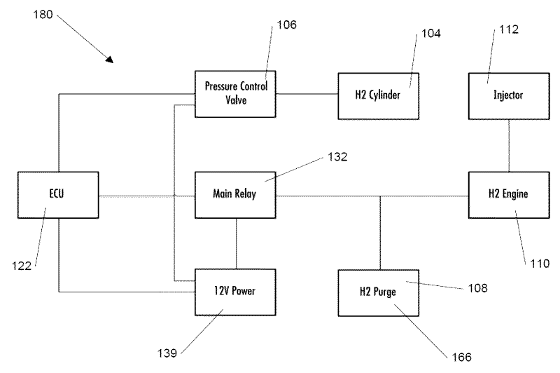

Referring to FIG. 3, the electronically controlled hydrogen combustion system 100 includes a safety system 180 that functions as an integrated, multi-layer protection framework for preventing, detecting, and responding to hydrogen-specific hazards. The safety system 180 may operate in coordination with the sensors 150, an electronic control unit 122, and the custom actuator network to provide automated safety responses and controlled shutdown protocols when abnormal conditions are detected.

The safety system 180 may comprise a plurality of pressure sensors, hydrogen concentration sensors, and temperature sensors configured to monitor hydrogen storage and combustion conditions. As described previously, the pressure sensors 162 may be positioned within the hydrogen cylinders 104, a supply manifold, and combustion chambers to provide continuous pressure feedback to the electronic control unit 122. The pressure monitoring subsystem may include a network of analog and digital pressure sensors positioned within the hydrogen cylinders 104, the supply manifold, and the combustion chambers. The hydrogen purge circuit sensors 166 may function as hydrogen concentration sensors that monitor hydrogen levels throughout the electronically controlled hydrogen combustion system 100. The temperature sensors 164 may be located on the hydrogen cylinders 104, an injector rail, and an ECU housing to monitor for abnormal heat buildup.

With continued reference to FIG. 3, the safety system 180 may include a hydrogen purge valve and a pressure regulating valve each connected to a hydrogen supply manifold. The purge valves 108 may function as the hydrogen purge valve, and the pressure regulating valves 106 may function as the pressure regulating valve. The pressure regulating valves 106 may receive control signals from the electronic control unit 122 to regulate hydrogen flow from the hydrogen cylinders 104 to the hydrogen fuel injectors 112. The purge valves 108 may be automatically actuated by the electronic control unit 122 to vent residual hydrogen during shutdown or upon detection of a leak condition.

The safety system 180 may include a master relay and at least one control relay configured to disconnect electrical power and hydrogen flow under abnormal conditions. The main relay 132 may function as the master relay, providing centralized power management and enabling system-wide deactivation during emergency conditions such as leak detection, sensor failure, or external operator command. The control relays 133 may function as the at least one control relay, governing hydrogen flow and ignition enablement under command from the electronic control unit 122.

As further shown in FIG. 3, the electronic control unit 122 may be electrically coupled to the sensors 150, the purge valves 108, the pressure regulating valves 106, and the relays. The electronic control unit 122 may be configured to receive sensor data in real time from the pressure sensors 162, the hydrogen purge circuit sensors 166, and the temperature sensors 164. The electronic control unit 122 may be configured to determine whether any monitored parameter exceeds a predetermined safety threshold.

In response to detecting such a condition, the electronic control unit 122 may be configured to deactivate hydrogen injection, disable ignition, and actuate the purge valves 108 to vent residual hydrogen. The electronic control unit 122 may command de-energization of the main relay 132 to disconnect electrical power to a hydrogen control valve, the ignition coils 114, and the custom actuator network during emergency shutdown conditions. The electronic control unit 122 may transmit control signals to the hydrogen fuel injectors 112 to halt fuel delivery and may disable the ignition coils 114 to prevent spark generation.

The safety system 180 may automatically return the engine to a safe state without operator intervention. The safety system 180 may be adaptable for use with single-cylinder through multi-cylinder engines. The modular architecture of the safety system 180 may allow consistent safety protection across engine configurations from single-cylinder engines to V16 layouts without requiring modification to the safety control logic executed by the electronic control unit 122.

A hydrogen pressure regulation assembly may comprise a pressure regulating valve and a purge valve in communication with the ECU 122. As described previously, the pressure regulating valves may control hydrogen gas flow from hydrogen storage cylinders to a hydrogen injector rail, maintaining output pressure within a predetermined range. The purge valve may be coupled to the injector rail and configured to vent residual hydrogen during engine shutdown or fault conditions. The hydrogen pressure regulation assembly may receive electronic commands from the ECU 122 to selectively actuate the pressure regulating valve and the purge valve based on real-time sensor data and operating conditions.

A pressure monitoring subsystem may track hydrogen cylinder and engine pressures through a network of analog and digital pressure sensors positioned within the hydrogen storage cylinder, a supply manifold, and combustion chambers. The pressure monitoring subsystem may provide continuous feedback to the ECU 122 regarding hydrogen storage pressure, supply line pressure, and combustion chamber pressure. The ECU 122 may process pressure data from the pressure monitoring subsystem and compare measured values against predetermined safety thresholds stored in ECU memory. When measured pressures exceed the predetermined thresholds, the ECU 122 may automatically close a hydrogen control valve to halt hydrogen supply to the engine. The ECU 122 may also disable injector actuation when pressure thresholds are exceeded to prevent hydrogen delivery under unsafe conditions.

The purge valve may automatically vent residual hydrogen upon engine shutdown or upon detection of overpressure by the pressure sensors. Upon detection of overpressure conditions by the pressure sensors, the ECU 122 may transmit control signals to actuate the purge valve, allowing residual hydrogen to be vented from fuel lines and the injector rail. The purge valve may also be actuated during normal engine shutdown sequences to remove residual hydrogen from enclosed spaces within the hydrogen pressure regulation assembly.

The ECU 122 may be configured to implement a purge and vent control sequence upon engine shutdown. The sequence may comprise timed activation of the purge valve and deactivation of hydrogen injectors to evacuate residual hydrogen from manifolds and injectors prior to restart. During the purge and vent control sequence, the ECU 122 may first deactivate the hydrogen injectors to halt fuel delivery, then activate the purge valve for a predetermined duration to evacuate residual hydrogen from the supply manifold and injector rail. The timed activation of the purge valve may ensure complete evacuation of hydrogen from fuel delivery components before the engine is restarted.

Fail-safe control relays may include specialized relays and solenoid valves that govern hydrogen flow and ignition enablement. The specialized relays may control electrical power to the hydrogen control valve and the purge valve. The solenoid valves may provide mechanical actuation for opening and closing hydrogen flow pathways within the hydrogen pressure regulation assembly. The ECU 122 may command immediate de-energization of relays upon fault detection, thereby halting fuel supply and spark generation. Upon detection of a fault condition such as overpressure, hydrogen leakage, or sensor anomaly, the ECU 122 may transmit de-energization commands to the specialized relays, causing the hydrogen control valve to close and the ignition system to be disabled. The de-energization of the relays may occur without operator intervention, providing automated safety response to detected fault conditions.

A three-layer hydrogen storage tank may supply hydrogen fuel to the electronically controlled hydrogen combustion system at variable pressures. The three-layer hydrogen storage tank may comprise a hydrogen storage cylinder having a three-layer construction that provides structural integrity and containment capability for high-pressure hydrogen storage.

The hydrogen storage cylinder may include an aluminum inner liner that forms the innermost layer of the three-layer construction. The aluminum inner liner may provide a hydrogen-impermeable barrier that prevents hydrogen permeation through the cylinder wall. The aluminum inner liner may be formed from aluminum alloy material selected for compatibility with hydrogen gas and resistance to hydrogen embrittlement. The aluminum inner liner may define the internal volume of the hydrogen storage cylinder and may be in direct contact with stored hydrogen gas.

A glass-fiber composite intermediate layer may surround the aluminum inner liner. The glass-fiber composite intermediate layer may provide structural reinforcement to the hydrogen storage cylinder. The glass-fiber composite intermediate layer may comprise glass fibers embedded in a resin matrix that transfers mechanical loads across the fiber reinforcement. The glass-fiber composite intermediate layer may be wound or wrapped around the aluminum inner liner to form a continuous reinforcement structure. The glass-fiber composite intermediate layer may bear hoop stress and axial stress generated by internal hydrogen pressure within the hydrogen storage cylinder.

A polymer outer shell may form the outermost layer of the three-layer construction. The polymer outer shell may comprise a polymer or epoxy outer layer that provides environmental protection for the glass-fiber composite intermediate layer. The polymer outer shell may protect the glass-fiber composite intermediate layer from mechanical damage, ultraviolet radiation, and chemical exposure. The polymer outer shell may also provide impact resistance to protect the structural integrity of the hydrogen storage cylinder during handling and installation.

The three-layer construction of the hydrogen storage cylinder may be engineered to withstand high-pressure hydrogen containment. The cylinder may be configured to withstand hydrogen containment pressures exceeding 700 bar. The combination of the aluminum inner liner, the glass-fiber composite intermediate layer, and the polymer outer shell may provide a pressure vessel structure capable of safely containing hydrogen at pressures required for vehicular, marine, industrial, and stationary engine applications. The hydrogen storage cylinder may be certified to applicable safety standards for high-pressure hydrogen storage vessels.

The hydrogen storage cylinder may be configured to supply hydrogen at variable pressures to accommodate different operating conditions and engine configurations. The pressure regulating valves, as described previously, may receive hydrogen from the hydrogen storage cylinder and regulate output pressure to the hydrogen fuel injectors based on engine demand and operating conditions.

The electronically controlled hydrogen combustion system may include fail-safe control relays comprising specialized relays and solenoid valves that govern hydrogen flow and ignition enablement. The specialized relays may control electrical power distribution to hydrogen control valves, purge valves, and ignition circuits. The solenoid valves may provide mechanical actuation for opening and closing hydrogen flow pathways within the hydrogen pressure regulation assembly and fuel delivery system. The fail-safe control relays may be configured to default to a de-energized state that halts hydrogen flow and disables ignition when electrical power is removed or when commanded by the ECU 122.

The ECU 122 may command immediate de-energization of the fail-safe control relays upon fault detection. Upon detection of a fault condition such as overpressure, hydrogen leakage, sensor anomaly, or combustion irregularity, the ECU 122 may transmit de-energization commands to the specialized relays. The de-energization of the specialized relays may cause hydrogen control valves to close, thereby halting fuel supply to the engine. The de-energization may also disable ignition circuits to prevent spark generation during fault conditions. The ECU 122 may execute de-energization commands without operator intervention, providing automated safety response to detected fault conditions.

A master relay emergency shutdown protocol may provide centralized power management for disconnecting electrical power during emergency conditions. The master relay may be configured to disconnect electrical power to a hydrogen control valve, the ignition system, and an actuator network during emergency shutdown conditions initiated by the ECU 122 in response to a detected anomaly. Upon initiation of the emergency shutdown protocol, the ECU 122 may transmit a de-energization command to the master relay, causing the master relay to open and interrupt electrical power to downstream components. The disconnection of electrical power by the master relay may simultaneously disable hydrogen injection, ignition, and actuator functions to return the engine to a safe state.

Thermal protection may be provided through temperature monitoring and automatic power reduction. Over-temperature conditions may trigger automatic power reduction or controlled shutdown. Temperature sensors positioned at locations including the cylinder head, exhaust manifold, and ECU housing may provide thermal data to the ECU 122. When temperature measurements exceed predetermined thermal thresholds, the ECU 122 may reduce power output by adjusting hydrogen injection rate and ignition timing. If over-temperature conditions persist or exceed higher threshold values, the ECU 122 may initiate a controlled shutdown sequence to prevent thermal damage to engine components and electronic systems.

Electrical protection may be provided through relays and fuses configured to prevent over-current events. Electrical relays and fuses may prevent over-current events and isolate high-voltage circuits. Fuses may be positioned in electrical circuits supplying power to the ECU 122, sensors, and actuators. Upon occurrence of an over-current condition, fuses may open to interrupt current flow and prevent damage to electrical components. Relays may isolate high-voltage circuits associated with the ignition system from low-voltage control circuits to prevent electrical faults from propagating through the control system.

The ECU 122 may be configured to execute software-based fault diagnostics that cross-check real-time sensor data for plausibility. The software-based fault diagnostics may include embedded firmware routines that continuously cross-check sensor signals for plausibility. The embedded firmware routines may compare sensor readings against expected value ranges, rate-of-change limits, and cross-correlation relationships between related sensors. For example, the firmware routines may compare manifold absolute pressure readings against throttle position and engine speed to verify plausibility of the pressure measurement. The firmware routines may also compare readings from redundant sensors to detect sensor drift or failure.

In the event of inconsistency or sensor loss, the ECU 122 may default to a safe state by disabling hydrogen injection and logging the event for review. Upon detection of an anomaly through the software-based fault diagnostics, the ECU 122 may deactivate one or more hydrogen injectors and initiate a controlled system shutdown. The ECU 122 may transmit control signals to halt pulse-width modulated fuel delivery from affected hydrogen injectors. The ECU 122 may also disable ignition coils to prevent combustion during the shutdown sequence. The ECU 122 may log fault codes and sensor data associated with the detected anomaly to non-volatile memory for subsequent diagnostic review. The logged data may include timestamp information, sensor readings at the time of fault detection, and identification of the specific plausibility check that triggered the fault condition.

The electronically controlled hydrogen combustion system 100 may include an artificial intelligence and large-language-model (AI/LLM) optimization module 190 configured to work cooperatively with the electronic control unit 122 and the sensors 150. The AI/LLM optimization module 190 may augment the electronic control unit 122 through data-driven learning, inference, and recommendation processes that refine engine performance, safety, and predictive maintenance. The AI/LLM optimization module 190 may not replace the real-time control provided by the electronic control unit 122 but may provide supplemental analysis and optimization capabilities.

The AI/LLM optimization module 190 may receive real-time data from multiple sensors including the temperature sensors 164, the pressure sensors 162, the knock sensors 154, the lambda sensors 160, the throttle position sensors 152, the crank sensors 156, and the cam sensors 158. The AI/LLM optimization module 190 may evaluate sensor data in aggregate with stored historical patterns maintained in a data repository accessible to the AI/LLM optimization module 190. The stored historical patterns may include prior sensor readings, combustion performance metrics, and operational data collected during previous engine operation cycles. The AI/LLM optimization module 190 may compare current sensor data against the stored historical patterns to identify deviations from expected operating conditions.

The AI/LLM optimization module 190 may identify correlations between hydrogen injection timing, ignition advance, and measured combustion results using machine-learning techniques. The machine-learning techniques may include supervised learning algorithms trained on datasets comprising sensor inputs and corresponding combustion outcomes. The AI/LLM optimization module 190 may process sensor data through trained machine-learning models to predict combustion efficiency, emissions characteristics, and thermal performance based on current injection timing and ignition advance settings. The machine-learning models may identify non-linear relationships between control parameters and combustion results that may not be captured by conventional lookup tables stored in the electronic control unit 122.

The AI/LLM optimization module 190 may communicate adaptive correction signals or advisory parameters back to the electronic control unit 122 for live adjustment or scheduled calibration when efficiency deviations or safety-critical trends are detected. When the AI/LLM optimization module 190 detects efficiency deviations from target performance metrics, the AI/LLM optimization module 190 may generate adaptive correction signals specifying adjustments to hydrogen injector pulse width, ignition timing advance, or pressure regulation setpoints. The electronic control unit 122 may receive the adaptive correction signals and implement the specified adjustments during live engine operation. When the AI/LLM optimization module 190 detects safety-critical trends such as increasing knock frequency or thermal anomalies, the AI/LLM optimization module 190 may transmit advisory parameters to the electronic control unit 122 for scheduled calibration during subsequent maintenance intervals.

The AI/LLM optimization module 190 may interpret structured and unstructured diagnostic data, maintenance logs, and ECU fault codes to classify likely fault conditions based on semantic pattern matching. The AI/LLM optimization module 190 may process structured diagnostic data including numerical sensor readings, timestamp information, and fault code identifiers stored by the electronic control unit 122. The AI/LLM optimization module 190 may also process unstructured diagnostic data including text-based maintenance logs and operator notes. The AI/LLM optimization module 190 may apply semantic pattern matching algorithms to correlate diagnostic data with known fault signatures stored in a fault classification database. The semantic pattern matching may enable the AI/LLM optimization module 190 to classify fault conditions based on combinations of symptoms that may not individually indicate a specific fault.

The AI/LLM optimization module 190 may generate human-readable diagnostic summaries for operators through a software interface. The diagnostic summaries may describe detected fault conditions, probable causes, and recommended corrective actions in natural language text. The diagnostic summaries may be displayed on the software interface to provide operators with interpretable information regarding engine status and maintenance requirements. The natural language generation capability of the AI/LLM optimization module 190 may translate technical fault codes and sensor data into descriptions accessible to operators without specialized technical training.

The AI/LLM optimization module 190 may recommend parameter adjustments, such as ignition offset or injector pulse-width modification, in textual or structured command format. The parameter adjustment recommendations may specify numerical values for ignition timing offset, hydrogen injector pulse width, or pressure regulation setpoints. The recommendations may be presented in textual format through the software interface for operator review and approval. The recommendations may also be presented in structured command format compatible with the electronic control unit 122 for direct implementation upon operator authorization. The structured command format may include parameter identifiers, target values, and applicable operating conditions for the recommended adjustments.

The AI/LLM optimization module 190 may correlate environmental factors with engine response for improved calibration. The environmental factors may include altitude, humidity, and hydrogen purity. The AI/LLM optimization module 190 may receive environmental data from external sensors or data inputs and correlate the environmental data with engine performance metrics measured by the sensors 150. The correlation analysis may identify relationships between environmental conditions and combustion characteristics that affect engine efficiency and emissions. The AI/LLM optimization module 190 may generate calibration recommendations that account for environmental factors to maintain consistent engine performance across varying operating environments.

A large language model (LLM) component of the AI/LLM optimization module 190 may be locally hosted or cloud-connected. When locally hosted, the LLM component may execute on processing hardware integrated with or communicatively coupled to the electronic control unit 122. When cloud-connected, the LLM component may execute on remote server infrastructure accessible through a secure network connection. The cloud-connected configuration may allow model updates to be deployed to the AI/LLM optimization module 190 without altering firmware stored in the electronic control unit 122. Model updates may include updated machine-learning model weights, expanded fault classification databases, and refined semantic pattern matching algorithms. The separation of the LLM component from the electronic control unit 122 firmware may enable continuous improvement of the AI/LLM optimization module 190 capabilities while maintaining stability of the real-time control functions executed by the electronic control unit 122.

The AI/LLM optimization module 190 may maintain a continuously updated data model of system behavior. The continuously updated data model may comprise a structured repository of operational data collected from sensors during engine operation. The data model may store time-series records of sensor readings including temperature measurements, pressure measurements, knock sensor outputs, lambda sensor readings, throttle position values, and crankshaft and camshaft position data. The data model may also store derived metrics computed from the raw sensor data, including combustion efficiency calculations, emissions estimates, and thermal performance indicators. The continuously updated data model may be incrementally updated during engine operation as new sensor data are received by the AI/LLM optimization module 190. The incremental updates may enable the data model to reflect current operating conditions and recent operational history without requiring complete reprocessing of historical data.

The AI/LLM optimization module 190 may compute predictive metrics during operation based on analysis of the continuously updated data model. The predictive metrics may include an expected combustion stability index based on recent knock sensor data. The combustion stability index may quantify the consistency of combustion events across engine cycles and may indicate the likelihood of abnormal combustion conditions such as pre-ignition, detonation, or misfire. The AI/LLM optimization module 190 may compute the combustion stability index by analyzing statistical properties of knock sensor signals over a rolling time window. The statistical properties may include signal amplitude variance, frequency content, and temporal patterns of knock events. An increasing trend in the combustion stability index may indicate degrading combustion quality that may precede detectable fault conditions. A decreasing trend in the combustion stability index may indicate improving combustion stability resulting from adaptive control adjustments.

The AI/LLM optimization module 190 may compute optimal air-to-fuel ratio bias under transient throttle conditions. Transient throttle conditions may occur during acceleration, deceleration, and load changes when throttle position changes rapidly. During transient throttle conditions, steady-state air-to-fuel ratio maps stored in electronic control unit memory may not accurately reflect instantaneous combustion requirements. The AI/LLM optimization module 190 may analyze historical data correlating throttle position rate-of-change with measured air-to-fuel ratio deviations and combustion outcomes. Based on the correlation analysis, the AI/LLM optimization module 190 may compute an optimal air-to-fuel ratio bias value that compensates for transient effects. The optimal air-to-fuel ratio bias may specify a temporary enrichment or enleanment of the hydrogen-air mixture during throttle transients to maintain combustion stability and minimize emissions.

The AI/LLM optimization module 190 may compute remaining component life inferred from duty-cycle history. The remaining component life computation may apply to components subject to wear or degradation during engine operation, including hydrogen injectors and ignition coils. The AI/LLM optimization module 190 may track duty-cycle history for each component, including cumulative operating time, number of actuation cycles, and operating conditions during actuation. The duty-cycle history may be stored in the continuously updated data model and may be correlated with component degradation models. The component degradation models may specify expected wear rates and failure probabilities as functions of duty-cycle parameters. The AI/LLM optimization module 190 may compute remaining component life by comparing accumulated duty-cycle history against the component degradation models. The remaining component life computation may yield an estimated time or number of operating cycles until component replacement is recommended.

The AI/LLM optimization module 190 may share predictive outputs with the electronic control unit 122 to enable pre-emptive adjustments. The predictive outputs may include the combustion stability index, the optimal air-to-fuel ratio bias, and the remaining component life estimates. The AI/LLM optimization module 190 may transmit the predictive outputs to the electronic control unit 122 through a communication interface such as a Controller Area Network bus or a dedicated data link. The electronic control unit 122 may receive the predictive outputs and incorporate the predictive information into control decisions. For example, the electronic control unit 122 may apply the optimal air-to-fuel ratio bias during detected throttle transients to improve combustion stability. The electronic control unit 122 may also adjust ignition timing or hydrogen injection parameters based on the combustion stability index to prevent degradation of combustion quality.

The AI/LLM optimization module 190 may issue maintenance alerts before component failure or efficiency loss based on the predictive outputs. When the remaining component life computation indicates that a component is approaching end-of-life, the AI/LLM optimization module 190 may generate a maintenance alert. The maintenance alert may specify the affected component, the estimated remaining life, and a recommended maintenance action. The maintenance alert may be transmitted to a software interface for display to an operator. The maintenance alert may also be logged in a maintenance record accessible for fleet management or service scheduling purposes. The pre-emptive maintenance alerts may enable component replacement before failure occurs, reducing unplanned downtime and preventing secondary damage that may result from component failure during operation.

The AI/LLM optimization module 190 may also issue efficiency loss alerts when predictive metrics indicate declining engine performance. The efficiency loss alerts may be generated when the combustion stability index exceeds a threshold value indicating unstable combustion, when air-to-fuel ratio deviations exceed acceptable limits during transient conditions, or when component degradation affects combustion efficiency. The efficiency loss alerts may prompt operator review of engine operating parameters and may recommend diagnostic procedures to identify root causes of efficiency degradation. The combination of pre-emptive adjustments enabled by predictive outputs and maintenance alerts issued before component failure may support sustained engine performance and reliability across extended operating periods.

A software interface may be configured to display real-time parameters, record performance data, and facilitate diagnostics and remote monitoring. The software interface may provide a software platform that communicates with the electronic control unit via the Controller Area Network protocol to provide actionable insights regardless of engine type or use case. The software interface may be universally compatible across engine configurations from single-cylinder engines to V16 layouts and across applications including vehicular, marine, industrial, and stationary engines.

The software interface may provide real-time visualization that displays parameters for any engine. The real-time visualization may display air-to-fuel ratio, temperature, cylinder pressure, and power output in real time. The air-to-fuel ratio display may present lambda sensor readings in numerical and graphical formats, enabling operators to monitor combustion stoichiometry during engine operation. The temperature display may present readings from temperature sensors positioned at the intake, exhaust, and cylinder head locations. The cylinder pressure display may present manifold absolute pressure and combustion chamber pressure measurements from pressure sensors distributed throughout the engine. The power output display may present calculated engine power based on sensor data including throttle position, engine speed, and manifold pressure. The real-time visualization may also display fuel consumption data derived from hydrogen injector pulse width and injection frequency. The real-time parameters may be updated continuously during engine operation to reflect instantaneous operating conditions.

The software interface may provide data logging that records performance data for analysis. The data logging capability may be scalable to application needs across vehicular, marine, industrial, and stationary engine installations. The data logging may record time-series data from all sensors connected to the electronic control unit, including temperature sensors, pressure sensors, knock sensors, lambda sensors, crankshaft and camshaft position sensors, and throttle position sensors. The recorded performance data may include raw sensor readings, derived parameters such as air-to-fuel ratio and power output, and control outputs including hydrogen injector pulse width and ignition timing values. The data logging may store recorded data in non-volatile memory accessible for subsequent retrieval and analysis. The recorded performance data may be exported in standardized file formats compatible with external analysis software. The data logging capability may support configurable recording intervals and data retention periods to accommodate storage capacity constraints and analysis requirements for different applications.

The software interface may provide diagnostics that alert users to errors and maintenance needs. The diagnostic capability may be effective across all setups from single-cylinder engines to multi-cylinder configurations. The diagnostics may monitor sensor readings and control system status to detect error conditions including sensor failures, communication faults, and out-of-range parameter values. Upon detection of an error condition, the diagnostics may generate an alert that is displayed on the software interface to notify the operator. The diagnostic alerts may include fault code identifiers, affected component descriptions, and recommended corrective actions. The diagnostics may also monitor component operating parameters and usage metrics to identify maintenance needs before component failure occurs. Maintenance alerts may be generated when component duty-cycle history indicates approaching end-of-life or when performance degradation trends are detected. The diagnostic alerts and maintenance alerts may be logged in a diagnostic history record accessible through the software interface for review of past events and maintenance planning.

The software interface may support remote monitoring for management and predictive maintenance for diverse applications. The remote monitoring capability may enable access to real-time parameters, recorded performance data, and diagnostic information from locations remote from the engine installation. The remote monitoring may be implemented through a secure network connection that transmits data from the software interface to remote monitoring stations or cloud-based management platforms. The remote monitoring may support fleet management applications where multiple engines are monitored from a centralized location. The remote monitoring may also support predictive maintenance by enabling analysis of operational data from multiple engines to identify common failure patterns and optimize maintenance schedules. The remote monitoring capability may provide notifications to remote operators when diagnostic alerts or maintenance alerts are generated, enabling timely response to detected conditions regardless of operator proximity to the engine installation.

Engine modifications may enable hydrogen operation across conventional internal combustion engines regardless of original fuel type or cylinder configuration. The engine modifications may address the distinct combustion characteristics of hydrogen fuel, including high flame speed, low ignition energy, and wide flammability range, that differ from conventional hydrocarbon fuels.

Combustion chamber optimization may be adapted to accommodate hydrogen's high flame speed and low ignition energy. The high flame speed of hydrogen may result in rapid combustion propagation that differs from the combustion characteristics of gasoline or diesel fuels. Combustion chamber geometry may be modified to accommodate the rapid flame propagation associated with hydrogen combustion. The combustion chamber modifications may include alterations to chamber shape, volume, and surface characteristics to promote controlled combustion and reduce the likelihood of pre-ignition or detonation. The low ignition energy of hydrogen may enable ignition at lower spark energy levels than required for hydrocarbon fuels. The combustion chamber optimization may account for the low ignition energy by configuring spark plug positioning and electrode gap dimensions to achieve reliable ignition while minimizing the risk of unintended ignition from hot surfaces or residual combustion products. The combustion chamber optimization may be customized for each engine type to accommodate variations in cylinder bore, stroke, compression ratio, and valve configuration across different engine architectures.

High-energy ignition coils may provide precise spark control for hydrogen combustion. The high-energy ignition coils may generate high-voltage discharges with controlled energy delivery to ignite the hydrogen-air mixture within each combustion chamber. The high-energy ignition coils may be adjustable to the number of cylinders in the engine configuration. For single-cylinder engines, a single high-energy ignition coil may provide spark generation for the single combustion chamber. For multi-cylinder engines including inline, V-type, and opposed configurations, multiple high-energy ignition coils may be provided with one high-energy ignition coil corresponding to each cylinder. The number of high-energy ignition coils may scale from one coil for single-cylinder engines to sixteen coils for V16 engine configurations.

The high-energy ignition coils may be adjustable to combustion demands across different operating conditions. The high-energy ignition coils may deliver variable spark energy based on engine load, speed, and combustion requirements. Under light load conditions, the high-energy ignition coils may deliver lower spark energy sufficient to ignite lean hydrogen-air mixtures. Under high load conditions, the high-energy ignition coils may deliver higher spark energy to ensure reliable ignition of richer hydrogen-air mixtures and to overcome increased cylinder pressures. The adjustability of the high-energy ignition coils may enable consistent ignition performance across the full operating range of the engine from idle to maximum power output.

A method for controlling a hydrogen combustion engine through software-based monitoring and adaptive regulation may provide closed-loop feedback control across any engine configuration operating on hydrogen fuel. The method may be applicable to single-cylinder engines, multi-cylinder engines, and engine configurations including inline, V-type, and opposed cylinder arrangements. The method may enable consistent hydrogen combustion control across vehicular, marine, industrial, and stationary engine applications.

The method may comprise receiving, by an electronic control unit (ECU), continuous data signals from a plurality of sensors measuring temperature, pressure, knock, air-to-fuel ratio, and rotational position. The continuous data signals may be received at sampling rates sufficient to capture dynamic changes in engine operating conditions during transient and steady-state operation. Temperature data signals may be received from temperature sensors positioned at intake, exhaust, and cylinder head locations. Pressure data signals may be received from pressure sensors including manifold absolute pressure sensors and cylinder pressure sensors. Knock data signals may be received from knock sensors configured to detect abnormal combustion events including pre-ignition and detonation. Air-to-fuel ratio data signals may be received from lambda sensors positioned in exhaust gas pathways. Rotational position data signals may be received from crankshaft and camshaft position sensors that track angular position of rotating engine components.

The method may comprise processing the data through embedded control algorithms stored in ECU memory. The embedded control algorithms may comprise software routines executed by microprocessors within the electronic control unit. The embedded control algorithms may include lookup tables, mathematical functions, and conditional logic structures that convert sensor input data into control output commands. The embedded control algorithms may be stored in non-volatile memory within the electronic control unit and may be executed in real time during engine operation. The processing of data through the embedded control algorithms may include analog-to-digital conversion of sensor signals, filtering to remove noise from sensor data, and computation of derived parameters from raw sensor measurements.

The method may comprise determining injector pulse width and ignition timing values based on current load and speed conditions. The injector pulse width may specify the duration of hydrogen injector opening for each injection event. The ignition timing values may specify the crankshaft angle at which ignition coils are triggered to initiate combustion. Current load conditions may be determined from manifold absolute pressure, throttle position, and other sensor inputs that indicate engine power demand. Current speed conditions may be determined from crankshaft position sensor data that indicates engine rotational velocity. The embedded control algorithms may access lookup tables or compute mathematical functions that map load and speed conditions to corresponding injector pulse width and ignition timing values.

Determining injector pulse width and ignition timing values may comprise dynamically adjusting fuel injection timing based on manifold absolute pressure, throttle position, and crankshaft angle received from the plurality of sensors. The manifold absolute pressure may indicate intake manifold vacuum or boost pressure that correlates with engine load. The throttle position may indicate operator demand for engine power output. The crankshaft angle may indicate the instantaneous rotational position of the crankshaft relative to a reference position. The embedded control algorithms may combine manifold absolute pressure, throttle position, and crankshaft angle data to compute fuel injection timing that delivers hydrogen to each combustion chamber at an appropriate point in the engine cycle. The dynamic adjustment of fuel injection timing may occur continuously during engine operation to accommodate changes in load and speed conditions.

The method may comprise transmitting control signals from the ECU to a plurality of actuators including hydrogen injectors, ignition coils, and pressure valves to maintain target combustion parameters. The control signals transmitted to hydrogen injectors may comprise pulse-width modulated signals that control injector opening duration and timing. The control signals transmitted to ignition coils may comprise trigger signals that initiate high-voltage discharge at calculated crankshaft angles. The control signals transmitted to pressure valves may comprise actuation signals that adjust hydrogen supply pressure or vent residual hydrogen through purge valves. The target combustion parameters may include air-to-fuel ratio, combustion timing, and combustion stability metrics. The transmission of control signals may occur in real time to implement control commands computed by the embedded control algorithms.

The method may comprise monitoring for deviations between actual and desired operating conditions. The monitoring may compare measured sensor values against target setpoints or reference values stored in ECU memory. Deviations may be detected when measured values differ from target values by more than a threshold amount. The monitoring may include comparison of measured air-to-fuel ratio against target air-to-fuel ratio, comparison of measured combustion timing against target combustion timing, and comparison of measured temperature and pressure values against acceptable operating ranges. The monitoring may be performed continuously during engine operation to detect deviations as they occur.

The method may comprise automatically adjusting injection timing, ignition advance, or pressure regulation in response to said deviations to maintain stable hydrogen combustion and prevent unsafe operation. When deviations are detected, the embedded control algorithms may compute corrective adjustments to control parameters. Injection timing adjustments may advance or retard the crankshaft angle at which hydrogen injection occurs. Ignition advance adjustments may advance or retard the crankshaft angle at which ignition coils are triggered. Pressure regulation adjustments may increase or decrease hydrogen supply pressure through actuation of pressure regulating valves. The automatic adjustments may be computed and implemented without operator intervention. The automatic adjustments may maintain stable hydrogen combustion by returning operating conditions to target values. The automatic adjustments may prevent unsafe operation by responding to detected anomalies before fault conditions develop.

The method may further comprise detecting detonation via knock sensors and selectively retarding ignition timing for an affected cylinder in response to the detected detonation. Detonation may occur when the hydrogen-air mixture ignites prematurely or combustion propagates abnormally within a combustion chamber. Knock sensors may detect mechanical vibrations associated with detonation events and transmit corresponding electrical signals to the electronic control unit. The electronic control unit may process knock sensor signals to identify detonation events and determine which cylinder is affected. In response to detected detonation, the electronic control unit may selectively retard ignition timing for the affected cylinder. The selective retardation of ignition timing may reduce combustion chamber pressure and temperature at the time of ignition, thereby suppressing conditions that promote detonation. The selective retardation may be applied to the affected cylinder without altering ignition timing for other cylinders that are not experiencing detonation.

Automatically adjusting injection timing, ignition advance, or pressure regulation may comprise synchronizing crankshaft and camshaft position data to manage ignition and fuel timing across cylinder configurations including single-cylinder and multi-cylinder layouts. The crankshaft position data may indicate the angular position of the crankshaft relative to a reference position such as top dead center. The camshaft position data may indicate the angular position of the camshaft relative to a reference position and may identify the current engine cycle phase for each cylinder. The synchronization of crankshaft and camshaft position data may enable the electronic control unit to determine the appropriate timing for injection and ignition events for each cylinder. For single-cylinder layouts, the synchronization may coordinate injection and ignition timing with the single combustion chamber. For multi-cylinder layouts including inline, V-type, and opposed configurations, the synchronization may coordinate injection and ignition timing across all cylinders according to the firing order of the engine. The synchronization may enable consistent closed-loop feedback control across any cylinder configuration from single-cylinder engines to V16 layouts.

The electronically controlled hydrogen combustion system operates through coordinated interaction among multiple subsystems that collectively enable precise hydrogen combustion control, safety protection, and performance optimization across all engine configurations. The sensor network, electronic control unit, actuator network, safety system, artificial intelligence and large-language-model optimization module, and software interface function as an integrated control architecture in which each subsystem performs a distinct role while exchanging data and commands with other subsystems.

The sensor network serves as the input layer of the control architecture by continuously acquiring physical measurements from distributed sensor locations throughout the engine and hydrogen fuel delivery system. Temperature sensors, pressure sensors, knock sensors, lambda sensors, crankshaft and camshaft position sensors, and throttle position sensors each convert physical conditions into electrical signals that represent instantaneous operating states. The sensor network transmits these electrical signals to the electronic control unit through shielded signal lines or a Controller Area Network communication bus. The transmission of sensor data occurs at sampling rates sufficient to capture dynamic changes during transient engine operation, including acceleration, deceleration, and load changes. The sensor network provides the electronic control unit with the observational data required to compute control outputs and detect deviations from target operating conditions.

The electronic control unit receives continuous data streams from the sensor network and performs real-time processing to determine appropriate control actions. Onboard analog-to-digital converters digitize incoming sensor signals, and microprocessors execute embedded control algorithms stored in non-volatile memory. The embedded control algorithms process sensor data through lookup tables, mathematical functions, and conditional logic structures to compute hydrogen injector pulse width, ignition timing advance, and pressure regulation setpoints. The electronic control unit compares measured sensor values against target setpoints or reference maps to implement closed-loop feedback control. When deviations between actual and desired operating conditions are detected, the electronic control unit computes corrective adjustments and modifies control outputs to return operating conditions to target values. The closed-loop control architecture enables the electronic control unit to maintain stable hydrogen combustion under varying load, speed, and environmental conditions without operator intervention.

The actuator network receives control signals from the electronic control unit and executes commanded actions to regulate hydrogen combustion. Hydrogen injectors receive pulse-width modulated control signals that specify opening duration and timing for each injection event. Ignition coils receive trigger signals that initiate high-voltage discharge at calculated crankshaft angles to ignite the hydrogen-air mixture in each combustion chamber. Pressure regulating valves receive actuation signals that adjust hydrogen supply pressure from storage cylinders to the injector rail. Purge valves receive actuation signals that vent residual hydrogen during shutdown sequences or fault conditions. The actuator network converts electrical control signals into mechanical, electrical, or fluidic actions that directly affect combustion chamber conditions, fuel delivery rates, and system safety states. The coordination between the electronic control unit and the actuator network enables precise implementation of control commands computed from sensor data.

The safety system operates in parallel with the primary control functions to provide redundant protection against hydrogen-specific hazards. Pressure sensors, hydrogen concentration sensors, and temperature sensors within the safety system continuously monitor hydrogen storage and combustion conditions. The safety system compares measured values against predetermined safety thresholds stored in electronic control unit memory. When any monitored parameter exceeds a safety threshold, the safety system initiates automatic corrective actions without requiring operator intervention. The corrective actions may include deactivation of hydrogen injectors to halt fuel delivery, disabling of ignition coils to prevent spark generation, actuation of purge valves to vent residual hydrogen, and de-energization of relays to disconnect electrical power from hydrogen control valves and ignition circuits. The master relay provides centralized power management that enables system-wide deactivation during emergency conditions. The safety system returns the engine to a safe state through automated shutdown protocols that execute independently of primary control functions. The redundant protection provided by the safety system ensures that single-point failures in sensors, actuators, or control logic result in predictable safe responses rather than hazardous conditions.

The artificial intelligence and large-language-model optimization module augments electronic control unit operation through data-driven learning, inference, and recommendation processes. The optimization module receives real-time data from the sensor network and evaluates current sensor readings in aggregate with stored historical patterns maintained in a continuously updated data model. Machine-learning algorithms within the optimization module identify correlations between hydrogen injection timing, ignition advance, and measured combustion results that may not be captured by conventional lookup tables. When efficiency deviations or safety-critical trends are detected, the optimization module communicates adaptive correction signals or advisory parameters to the electronic control unit. The electronic control unit may implement adaptive corrections during live engine operation or schedule calibration adjustments for subsequent maintenance intervals. The optimization module also computes predictive metrics including combustion stability indices, optimal air-to-fuel ratio bias values for transient conditions, and remaining component life estimates based on duty-cycle history. The predictive metrics enable pre-emptive adjustments that maintain combustion quality and support maintenance planning before component failure or efficiency loss occurs. The optimization module interprets diagnostic data and generates natural-language maintenance advisories that translate technical fault codes into human-readable descriptions accessible through the software interface. The optimization module may operate locally on processing hardware coupled to the electronic control unit or may connect to remote server infrastructure through a secure network connection, enabling model updates without altering electronic control unit firmware.

The software interface provides operator visibility into system operation by displaying real-time parameters, recording performance data, and facilitating diagnostics and remote monitoring. The software interface communicates with the electronic control unit via the Controller Area Network protocol to receive sensor data, control outputs, and diagnostic information. Real-time visualization displays air-to-fuel ratio, temperature, cylinder pressure, power output, and fuel consumption in numerical and graphical formats that update continuously during engine operation. Data logging records time-series data from all sensors and control outputs to non-volatile memory for subsequent retrieval and analysis. Diagnostic functions monitor sensor readings and control system status to detect error conditions and generate alerts that notify operators of faults and maintenance needs. The software interface also displays predictive outputs generated by the optimization module alongside real-time engine parameters to provide human-interpretable performance insights. Remote monitoring capabilities enable access to real-time parameters, recorded data, and diagnostic information from locations remote from the engine installation through secure network connections. The software interface supports fleet management applications where multiple engines are monitored from centralized locations and enables predictive maintenance through analysis of aggregated operational data.

The interaction among subsystems follows a continuous operational cycle during engine operation. The sensor network acquires physical measurements and transmits sensor data to the electronic control unit. The electronic control unit processes sensor data through embedded control algorithms and computes control outputs for the actuator network. The actuator network executes commanded actions that affect combustion chamber conditions and fuel delivery. The resulting changes in engine operating state are measured by the sensor network, completing the closed-loop feedback cycle. Concurrently, the safety system monitors sensor data for threshold exceedances and initiates protective actions when abnormal conditions are detected. The optimization module analyzes sensor data and historical patterns to generate adaptive corrections and predictive metrics that refine electronic control unit operation. The software interface receives data from the electronic control unit and the optimization module to provide operator visibility and enable remote monitoring. The coordinated interaction among all subsystems enables the electronically controlled hydrogen combustion system to maintain stable, efficient, and safe hydrogen combustion across engine configurations from single-cylinder engines to V16 layouts and across applications including vehicular, marine, industrial, and stationary engines.

The following description sets forth exemplary aspects of the present disclosure. It should be recognized, however, that such description is not intended as a limitation on the scope of the present disclosure. Rather, the description also encompasses combinations and modifications to those exemplary aspects described herein.

A number of implementations have been described. Nevertheless, it will be understood that various modifications may be made without departing from the spirit and scope of the disclosure. Accordingly, other implementations are within the scope of the following claims.

What is claimed:

1. An electronically controlled hydrogen combustion engine system, comprising:
a plurality of hydrogen injectors configured for pulse-width modulated fuel delivery, each injector corresponding to a respective engine cylinder;
an ignition system comprising at least one ignition coil per cylinder;
a plurality of sensors comprising temperature sensors, pressure sensors, knock sensors, lambda sensors, crankshaft and camshaft position sensors, and a throttle position sensor;
an electronic control unit (ECU) in electronic communication with the plurality of sensors and the ignition system, the ECU configured to:
process real-time sensor data;
control hydrogen injector timing and pulse width;
adjust ignition timing based on combustion conditions; and
execute safety and shutdown protocols when abnormal conditions are detected;
a hydrogen pressure regulation assembly comprising a pressure regulating valve and a purge valve in communication with the ECU; and
a software interface configured to display real-time parameters, record performance data, and facilitate diagnostics and remote monitoring.

2. The system of claim 1, wherein the system is scalable and configurable for engines having from one to sixteen cylinders and for applications including vehicular, marine, industrial, and stationary engines.

3. The system of claim 1, wherein the ECU communicates with the plurality of sensors and the plurality of hydrogen injectors via a Controller Area Network (CAN) protocol to provide modular scalability for multi-cylinder configurations.

4. The system of claim 1, wherein the ECU dynamically adjusts fuel injection timing based on manifold absolute pressure, throttle position, and crankshaft angle to optimize combustion efficiency.

5. The system of claim 1, further comprising a three-layer hydrogen storage tank having an aluminum inner liner, a glass fiber intermediate layer, and a polymer outer shell, configured to supply hydrogen at variable pressures.

6. The system of claim 1, wherein the knock sensors are configured to detect detonation in any cylinder and the ECU selectively retards ignition timing for an affected cylinder in response to detected detonation.

7. The system of claim 1, wherein the software interface displays air-to-fuel ratio, temperature, cylinder pressure, and power output in real time.

8. The system of claim 1, further comprising a battery management system managing a lithium iron phosphate battery that powers the ECU and the plurality of sensors.

9. The system of claim 1, wherein the purge valve automatically vents residual hydrogen upon engine shutdown or upon detection of overpressure by the pressure sensors.

10. The system of claim 1, wherein the ECU performs adaptive learning of ignition timing parameters for different engine architectures via calibration algorithms stored in ECU memory.

11. The system of claim 10, wherein the ECU synchronizes crankshaft and camshaft position data from the crankshaft and camshaft position sensors to manage ignition and fuel timing across cylinder configurations including single-cylinder and V16 layouts.

12. An integrated safety control system for a hydrogen-fueled internal combustion engine, comprising:
a plurality of pressure sensors, hydrogen concentration sensors, and temperature sensors configured to monitor hydrogen storage and combustion conditions;
a hydrogen purge valve and a pressure regulating valve each connected to a hydrogen supply manifold;
a master relay and at least one control relay configured to disconnect electrical power and hydrogen flow under abnormal conditions;
an electronic control unit (ECU) electrically coupled to the sensors, the purge valve, the pressure regulating valve, and the relays, the ECU being configured to:
receive sensor data in real time;
determine whether any monitored parameter exceeds a predetermined safety threshold; and
in response to detecting such a condition, deactivate hydrogen injection, disable ignition, and actuate the purge valve to vent residual hydrogen,
wherein the system automatically returns the engine to a safe state without operator intervention and is adaptable for use with single-cylinder through multi-cylinder engines.

13. The system of claim 12, wherein the ECU is configured to execute software-based fault diagnostics that cross-check real-time sensor data for plausibility, and upon detection of an anomaly, deactivate one or more hydrogen injectors and initiate a controlled system shutdown.

14. The system of claim 12, further comprising a hydrogen storage cylinder having a three-layer construction including an aluminum inner liner, a glass-fiber composite intermediate layer, and a polymer outer layer, the cylinder being configured to withstand hydrogen containment pressures exceeding 700 bar.

15. The system of claim 12, wherein the ECU is further configured to implement a purge and vent control sequence upon engine shutdown, the sequence comprising timed activation of the purge valve and deactivation of hydrogen injectors to evacuate residual hydrogen from manifolds and injectors prior to restart.

16. The system of claim 13, wherein the master relay is configured to disconnect electrical power to a hydrogen control valve, the ignition system, and an actuator network during emergency shutdown conditions initiated by the ECU in response to the detected anomaly.

17. A method for controlling a hydrogen combustion engine through software-based monitoring and adaptive regulation, the method comprising:
receiving, by an electronic control unit (ECU), continuous data signals from a plurality of sensors measuring temperature, pressure, knock, air-to-fuel ratio, and rotational position;
processing the data through embedded control algorithms stored in ECU memory;
determining injector pulse width and ignition timing values based on current load and speed conditions;
transmitting control signals from the ECU to a plurality of actuators including hydrogen injectors, ignition coils, and pressure valves to maintain target combustion parameters;
monitoring for deviations between actual and desired operating conditions; and
automatically adjusting injection timing, ignition advance, or pressure regulation in response to said deviations to maintain stable hydrogen combustion and prevent unsafe operation, wherein the method provides closed-loop feedback control across any engine configuration operating on hydrogen fuel.

18. The method of claim 17, wherein determining injector pulse width and ignition timing values comprises dynamically adjusting fuel injection timing based on manifold absolute pressure, throttle position, and crankshaft angle received from the plurality of sensors.

19. The method of claim 17, further comprising detecting detonation via knock sensors and selectively retarding ignition timing for an affected cylinder in response to the detected detonation.

20. The method of claim 19, wherein automatically adjusting injection timing, ignition advance, or pressure regulation comprises synchronizing crankshaft and camshaft position data to manage ignition and fuel timing across cylinder configurations including single-cylinder and multi-cylinder layouts.
